(19) United States
(12) Patent Application Publication
(10) Pub. No.: US 2009/0231320 A1
(43) Pub. Date: Sep. 17, 2009

(54) Plasma Display Device

(76) Inventors: Ken Kumakura, Miyazaki (JP); Yoshikazu Kanazawa, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/721,176

(22) PCT Filed: Jul. 6, 2005
(86) PCT No.: PCT/JP05/12501

§ 371 Date: Jun. 8, 2007

(51) Int. Cl. G06F 3/038; G09G 3/28

(52) U.S. Cl. 345/212; 345/60

(57) ABSTRACT

A plasma display device which stops power supply or drive of a device by detecting an abnormality. The plasma display device is provided with a panel section (11) which has an address electrode (14) and performs display based on inputted display data, and a circuit section having an address drive circuit (17). The plasma display device is further provided with a means (2) for calculating a switching number of times of the address drive circuit (17) based on the inputted one or more display data; a means (2) for calculating a predicted current value (predicted power consumption value) by predicting consumption at the address drive circuit, based on the switching number of times obtained by the calculation; a means (3) for detecting a current consumption value (actual power consumption value) actually consumed at the address drive circuit (17), based on the display data; and a means (2) for comparing the predicted power consumption value with the actual power consumption value and judging whether it is abnormal.

### TECHNICAL FIELD

The present invention relates to a plasma display device, and in particular, to a plasma display device which includes a panel portion having an address electrode and the like and performing display based on inputted display data and a circuit portion composed of an address drive circuit and the like.

### BACKGROUND ART

Conventionally, a display percentage and a sustain pulse output circuit power consumption are in an almost proportional relation as to a current of sustain discharge in a plasma display module or a plasma display device as shown in FIG. 6. Therefore, overcurrent determination is performed by predicting power consumption from the display percentage and comparing it with an actually detected current value so as to perform protected operation if determined to be abnormal (refer to Patent Document 1).

As for an address current, only current detection is performed so as to perform the protected operation only when the detected value exceeds a certain threshold. Patent Document 1: Japanese Patent Laid-Open Publication No. 2000-187466

In the case of a conventional technology, the address current significantly changes according to display contents rather than the display percentage. To be more specific, address drive circuit power consumption is low with entire black and 100% entire white, and it is high if every other line is white for instance as shown in FIG. 7. However, the power consumption increases almost in proportion to the display contents (number of times of switching) as shown in FIG. 3. Therefore, in the case where the protected operation is simply performed just by the overcurrent detection (exceeding a predetermined value of address current drive circuit power consumption), it is necessary to set a threshold of overcurrent protection higher than a maximum current value of normal operation as shown in FIG. 5. Thus, it was not possible to find a failure point A outside a protected operation area although it was possible to find a failure point B within the protected operation area.

For that reason, the protected operation is not performed until a current exceeding the threshold for operating the overcurrent protection passes on abnormality, which is one of the causes triggering smoke generation, ignition and the like.

An object of the present invention is to provide a plasma display device which has solved the problem and improved safety.

### DISCLOSURE OF THE INVENTION

The present invention computes the number of address pulses or the number of times of switching of an address drive circuit from inputted display data so as to predict an address current and a power consumption value. And it compares an actually detected current value (or a real power consumption value) with a predicted current value (or a predicted power consumption value). In the case where a difference of a predetermined value or more is detected, it is determined as abnormal and a power source and driving are stopped.

To be more specific, the present invention provides a plasma display device configured to specify cells to be displayed, including: an address electrode; and a drive circuit for supplying an address pulse to the address electrode based on inputted display data, characterized in that the device is provided with: computing means for counting the number of the address pulses supplied from the display data within a predetermined period; means for calculating the predicted power consumption value of the address drive circuit from a count from the computing means; means for detecting the real power consumption value of the address drive circuit; and means for comparing the predicted power consumption value with the real power consumption value.

According to the present invention, it is possible to obtain a plasma display device which detects an abnormal state earlier, prevents smoke generation and ignition and has improved safety.

### BRIEF DESCRIPTION OF THE DRAWINGS

FIG. 1 is a block diagram of a plasma display device according to a first embodiment;

FIG. 2 is an explanatory diagram of circuits of the plasma display device according to the first embodiment;

FIG. 3 is an explanatory diagram of a correlation between the number of times of switching and power consumption as to an address drive circuit of the plasma display device;

FIG. 4 is an explanatory diagram of a protected operation area according to the first embodiment;

FIG. 5 is an explanatory diagram of the protected operation area of a conventional plasma display device;

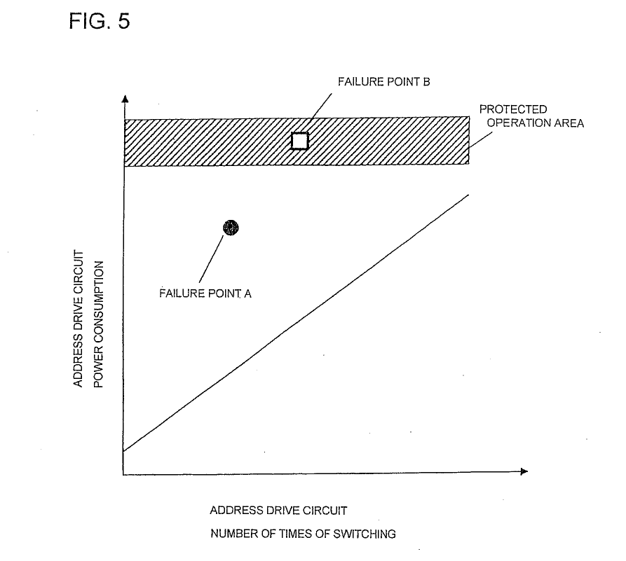

FIG. 6 is an explanatory diagram of a correlation between a display percentage and a sustain pulse output circuit power consumption; and

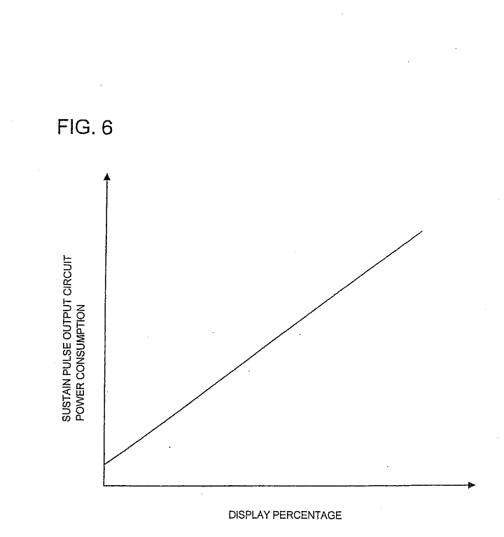

FIG. 7 is an explanatory diagram of a correlation between the display percentage and address drive circuit power consumption.

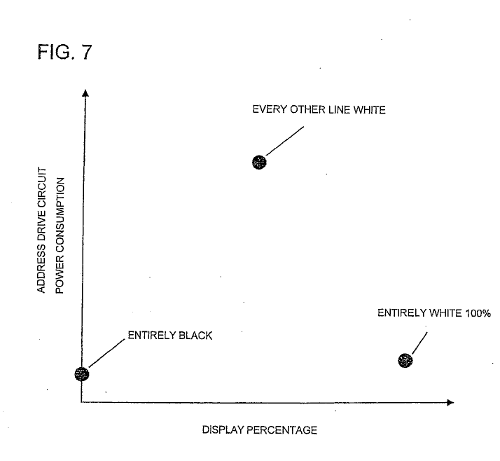

### DESCRIPTION OF SYMBOLS

1 Address drive circuit switching computing circuit
2 Microcomputer
3 Current detection circuit
4 Panel drive circuit
5 Drive control circuit
6 Power source
11 Display panel
12 Sustain electrode
13 Scan/sustain electrode
14 Address electrode
15 Sustain pulse output circuit
16 Scan/sustain pulse output circuit
17 Address drive circuit
18 Signal processing/drive control circuit

### BEST MODE FOR CARRYING OUT THE INVENTION

The best mode for carrying out the present invention will be described. Embodiments of a plasma display device according to the present invention will be described by using the drawings.

### First Embodiment

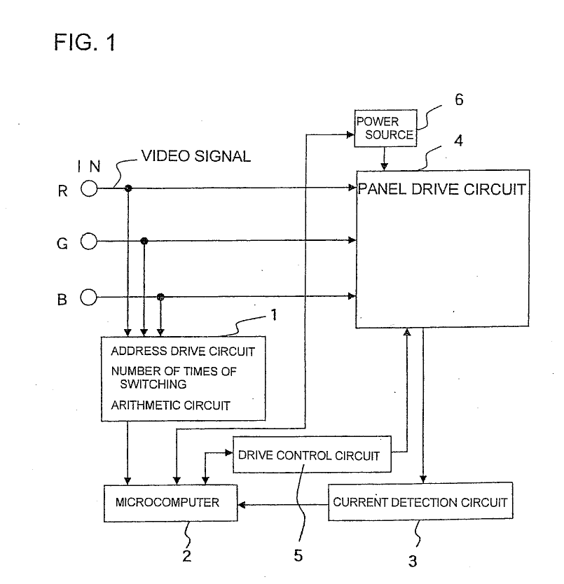

A first embodiment will be described. FIG. 1 is a block diagram of a plasma display device according to this embodiment. In the block diagram, reference numeral 1 denotes a number of times of switching computing circuit of an address drive circuit, 2 denotes a microcomputer, 3 denotes a current detection circuit, 4 denotes a panel drive circuit, 5 denotes a drive control circuit, and 6 denotes a power supply.

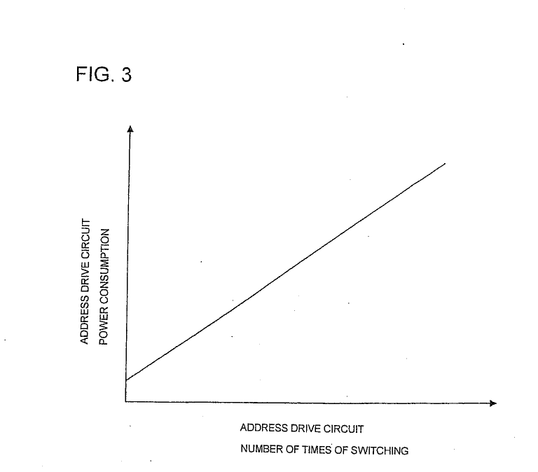

In FIG. 1, the number of times of switching computing circuit 1 counts the number of address pulses supplied to an address electrode or the number of times of switching of the address drive circuit as to each field period from inputted image data to be displayed. And it calculates a predicted power consumption value by computing or a table according to a relation shown in FIG. 3 for instance. At the same time, the current detection circuit 3 detects a drive current value of the address drive circuit out of the panel drive circuit 4 so as to obtain a real power consumption value. The drive control circuit 5 controls operation of the panel drive circuit 4 according to a command from the microcomputer 2. The power supply 6 supplies power supply voltage to each processing circuit portion of the plasma display device.

Here, the microcomputer 2 compares the predicted power consumption value from the number of times of switching computing circuit 1 with the real power consumption value from the current detection circuit 3. For instance, a difference value between the predicted power consumption value and the real power consumption value is compared with a predetermined value, and it is determined as abnormal in the case where the difference value is larger than the predetermined value.

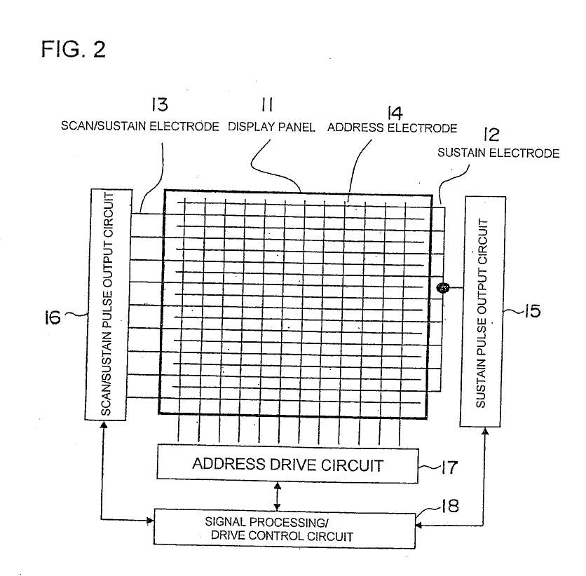

FIG. 2 is an explanatory diagram of the circuits of the plasma display device according to this embodiment. As against a sustain electrode 12, a scan/sustain electrode 13 and an address electrode 14 of a display panel 11, it has a sustain electrode pulse output circuit 15, a scan/sustain pulse output circuit 16, an address drive circuit 17 and a signal processing/drive control circuit 18 including the microcomputer 2 and drive control circuit 5 so as to produce an output to each of the electrodes according to an inputted video signal.

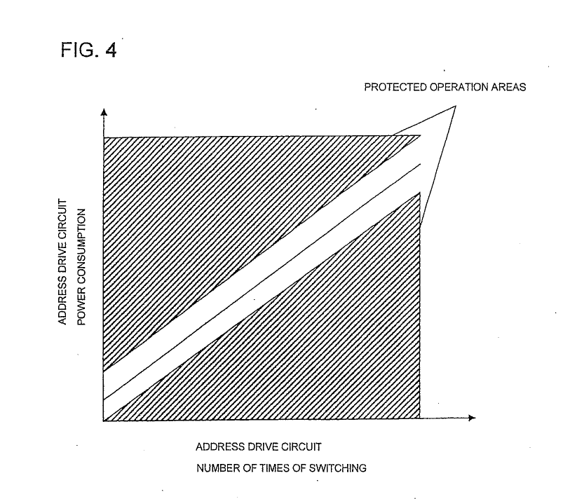

Power consumption of the address drive circuit 17 increases almost as a linear function against increase in the number of times of switching of the address drive circuit 17. Therefore, from the inputted video signal to be displayed, a predicted power value is calculated by computing a coefficient of the address pulses supplied from the address drive circuit 17 to the address electrode 14 or the number of times of switching of the address drive circuit 17 so as to compare the obtained predicted power value with the power consumption value of the address drive circuit 17 obtained by actual measurement. And it is determined as abnormal in the case where the difference exceeds a predetermined range, such as when a comparison result is within a protected operation area shown in FIG. 4. This determination is made by the microcomputer 2. If determined as abnormal, the power supply 6 is interrupted to stop supply of voltage to each processing circuit. It is also possible to exert control to stop the address drive circuit 17 via the drive control circuit 5.

It may also have a configuration in which display means such as an LED is installed on a front portion of the plasma display device to display the result of comparison between the predicted power consumption value and the real power consumption value from the microcomputer 2. This configuration allows a viewer of the plasma display device to recognize an abnormality of the device.

Furthermore, it may also be configured to have a method of communication with external apparatuses by means of a cable such as I²C bus, RS232C or USB. This configuration allows maintenance of the plasma display device to be efficiently performed.

According to the embodiment, the present invention was described as to the plasma display device including the sustain electrode, scan/sustain electrode and address electrode. However, the present invention can also be implemented by a plasma display device in another form having the address electrode.

### INDUSTRIAL APPLICABILITY

It is possible to obtain a plasma display device which can detect an abnormal state earlier and prevent smoke generation and ignition.

1. A plasma display device configured to specify cells to be displayed, including:
an address electrode; and
a drive circuit for supplying an address pulse to the address electrode based on inputted display data, characterized in that the device is provided with:
computing means for counting the number of the address pulses supplied from the display data within a predetermined period;
means for calculating the predicted power consumption value of the address drive circuit from a count from the computing means;
means for detecting the real power consumption value of the address drive circuit; and
means for comparing the predicted power consumption value with the real power consumption value.

2. The plasma display device according to claim 1, characterized in that the predetermined period is one field period.

3. The plasma display device according to claim 1, characterized in that the comparing means is configured to make a level comparison between a predetermined value and a difference value between the predicted power consumption value and the real power consumption value.

4. The plasma display device according to claim 3, characterized by:
including means for controlling a power source of the device; and
exerting control to interrupt the power source in the case where the difference value is the predetermined value or more.

5. The plasma display device according to claim 3, characterized by stopping driving operation of the address drive circuit in the case where the difference value is the predetermined value or more.

6. The plasma display device according to claim 1, characterized by including means for displaying a comparison result from the comparing means.

7. The plasma display device according to claim 1, characterized by including means for communicating the comparison result from the comparing means to outside of the device.

8. The plasma display device according to claim 2, characterized in that the comparing means is configured to make a level comparison between a predetermined value and a difference value between the predicted power consumption value and the real power consumption value.

9. The plasma display device according to claim 8, characterized by:
including means for controlling a power source of the device; and
exerting control to interrupt the power source in the case where the difference value is the predetermined value or more.

10. The plasma display device according to claim 8, characterized by stopping driving operation of the address drive circuit in the case where the difference value is the predetermined value or more.

11. The plasma display device according to claim 9, characterized by including means for displaying a comparison result from the comparing means.

12. The plasma display device according to claim 10, characterized by including means for communicating the comparison result from the comparing means to outside of the device.
